(19) United States
(12) Patent Application Publication
(10) Pub. No.: US 2009/0227913 A1
(43) Pub. Date: Sep. 10, 2009

(54) VEHICLE SEAT

(75) Inventors: Tomokazu Moriyama, Anjo-shi (JP); Fumitoshi AKAIKE, Aichi-ken (JP); Takashi Okada, Kariya-shi (JP); Sotaro Narita, Toyota-shi (JP)

Correspondence Address: GREENBLUM & BERNSTEIN, P.L.C., 1950 ROLAND CLARKE PLACE, RESTON, VA, 20191, US

(73) Assignees: TOYOTA BOSHOKU KABUSHIKI KAISHA, Aichi-ken (JP); AISIN SEIKI KABUSHIKI KAISHA, Aichi-ken (JP)

(21) Appl. No.: 12/397,375

(22) Filed: Mar. 4, 2009

(30) Foreign Application Priority Data
Mar. 7, 2008 (JP) 2008-057629
Mar. 7, 2008 (JP) 2008-057630

(51) Int. Cl. A61H 1/00

(52) U.S. Cl. 601/49

(57) ABSTRACT

A vehicle seat includes a seat pad having a passenger support surface, a vibratory device that is incorporated into the seat pad and a support member secured to the seat pad. The vibratory device is arranged and constructed to transmit vibration produced therefrom to a passenger sitting on the vehicle seat. The vibratory device is rotatably supported on the support member.

This application claims priority to Japanese patent application serial numbers 2008-057629 and 2008-057630, the contents of which are incorporated herein by reference.

### BACKGROUND OF THE INVENTION

1. Field of the Invention

The present invention relates to vehicle seats. More particularly, the present invention relates to vehicle seats having vibratory devices in which vibration of the vibratory devices can be transmitted to passengers sitting on the vehicle seats via seat seat pads.

2. Description of Related Art

A vehicle seat having a vibratory device is already known. Such a vehicle seat is taught, for example, by Japanese Laid-Open Patent Publication No. 2003-165404. In the vehicle seat, the vibratory device is attached to a seat cushion. The vibratory device is arranged and constructed so as to vibrate when an obstacle is detected by a sensor attached to a bumper, thereby notifying a passenger sitting on the vehicle seat of impending dangers.

Generally, in the vehicle seat, such a vibratory device may sometimes provide strong discomfort to the passenger when the passenger is sitting on the vehicle seat while the vibrating device is not operated, in particular, when the seat cushion is relatively thinned. This means that the vehicle seat can be comfortable to sit on.

Further, Japanese Laid-Open Patent Publication No. 2005-348815 teaches a massaging chair having an urethane pad. In the massaging chair, a vibratory device is embedded in the urethane pad, so that vibration of the vibratory device is transmitted to a sitting person sitting on the chair, thereby massaging the sitting person.

### BRIEF SUMMARY OF THE INVENTION

For example, in one aspect of the present invention, a vehicle seat may include includes a seat pad having a passenger support surface, a vibratory device that is incorporated into the seat pad and a support member secured to the seat pad. The vibratory device is arranged and constructed to transmit vibration produced therefrom to a passenger sitting on the vehicle seat. The vibratory device is rotatably supported on the support member.

According to this seat, when the vibratory device vibrates, the vibratory device can be oscillated about the support member, so as to repeatedly hit or impinge the seat pad. As a result, the vibration of the vibratory device can be transmitted to the passenger.

Also, the support member can be flexed with the seat pad. As a result, the vibratory device can be displaced in the same direction as the support member because the vibratory device is attached to the support member. Therefore, the vibratory device does not provide discomfort to the passenger when the vibrating device is not vibrated.

In one embodiment, the support member includes a wire member that is securely embedded in the seat pad. The wire member includes an uncovered attachment portion that is formed by partly removing the seat pad and an embedded portion that extends along the passenger support surface. The vibratory device is attached to the uncovered attachment portion, so that the vibration of the vibratory device can be transmitted along the passenger support surface.

In another embodiment, the support member includes an insert wire that is embedded in the seat pad. The seat pad is covered by a covering member, which is anchored to the insert wire via an anchor mechanism, so as to be fitted to the seat pad.

In a further embodiment, the support member includes an attachment bracket that is attached to the seat pad and the vibratory device is attached to the attachment bracket.

Other objects, features, and advantages, of the present invention will be readily understood after reading the following detailed description together with the accompanying drawings and the claims.

### BRIEF DESCRIPTION OF THE DRAWINGS

FIG. 1 is a perspective view of each of vehicle seats according to representative embodiments of the present invention;

FIG. 2 is an elevational view of a seat back of the vehicle seat according to a first embodiments of the present invention;

FIG. 3 is a cross-sectional view taken along line III-III in FIG. 2;

FIG. 4 is a cross-sectional view taken along line IV-IV in FIG. 2;

FIG. 5 is a diagrammatical view of vibratory devices, a wire member and related components that are embedded in a seat pad of the vehicle seat;

FIG. 6 is a view of a first modified form of the first embodiment, which view corresponds to FIG. 5;

FIG. 7 is a view of a second modified form of the first embodiment, which view corresponds to FIG. 5;

FIG. 8 is a view of a third modified form of the first embodiment, which view corresponds to FIG. 5;

FIG. 9 is a view of a fourth modified form of the first embodiment, which view corresponds to FIG. 5;

FIG. 10 is an elevational view of a seat back of the vehicle seat according to a second embodiments of the present invention;

FIG. 11 is a cross-sectional view taken along line XI-XI in FIG. 10;

FIG. 12 is a cross-sectional view taken along line XII-XII in FIG. 10;

FIG. 13 is a cross-sectional view taken along line XIII-XIII in FIG. 10;

FIG. 14 is an elevational view of a seat back of the vehicle seat according to a third embodiments of the present invention;

FIG. 15 is a perspective view of an attachment. bracket;

FIG. 16 is a cross-sectional view taken along line XVI-XVI in FIG. 14;

FIG. 17 is a view of a first modified form of the third embodiment, which view corresponds to FIG. 16; and

FIG. 18 is a perspective view of a second modified form of the third embodiment.

### DETAILED DESCRIPTION OF THE INVENTION

Representative examples of the present invention have been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

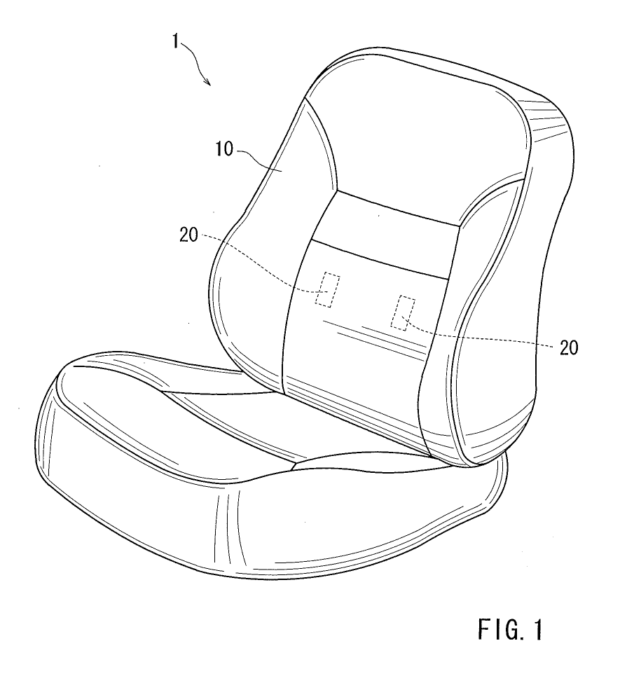

Detailed representative embodiments of the present invention are shown in FIG. 1 to FIG. 18.

### First Detailed Representative Embodiment

A first detailed representative embodiment of the present invention is shown in FIG. 1 to FIG. 5. Further, in this embodiment, a driver's seat is exemplified as a vehicle seat 1 of the embodiment.

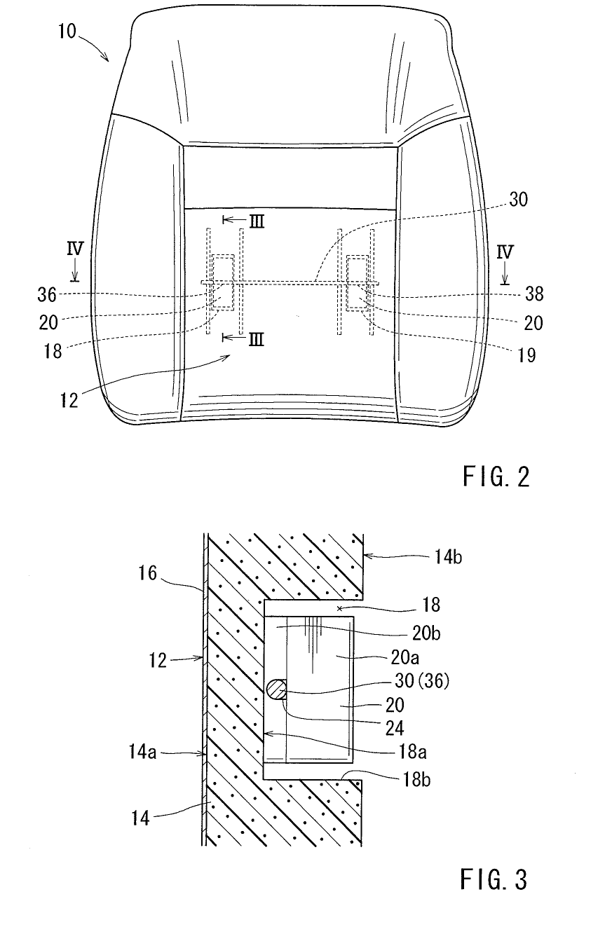

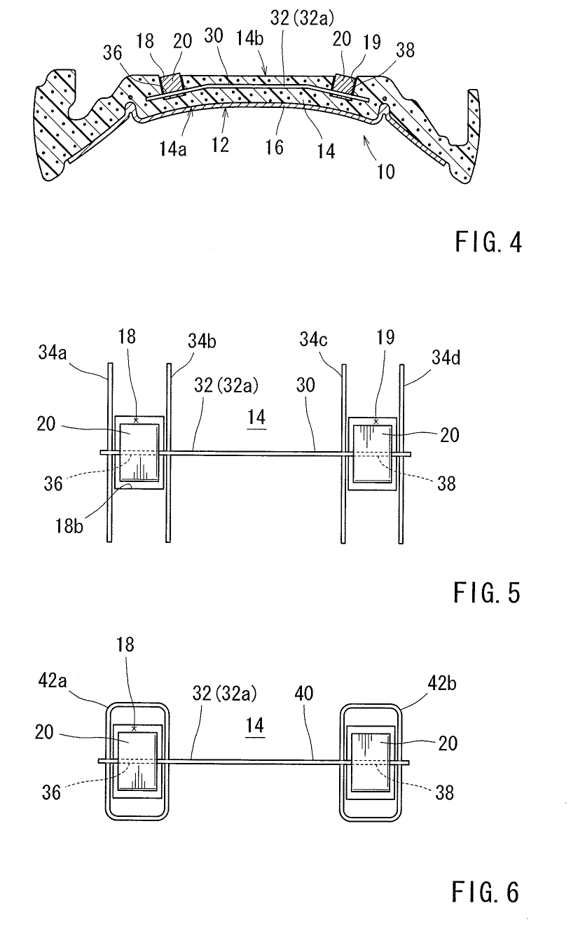

As shown in FIGS. 1 and 2, two vibratory devices 20 are attached to a seat back 10 of the vehicle seat 1. Each of the vibratory devices 20 used therein is capable of vibrating by eccentric rotation of a motor that is built therein. The vibratory devices 20 are incorporated into the seat back 10 such that a passenger (not shown) sitting on the vehicle seat 1 cannot directly touch the same. As shown in FIG. 4, the seat back 10 may preferably include a seat pad 14 having a passenger support surface 12. A front surface 14a of the seat pad 14 may preferably be covered by a covering member 16. Formed in the seat pad 14 are a pair of bottomed bores or recesses 18 and 19 by partly removing the same. The recesses 18 and 19 are opened to a rear surface 14b that is opposite to the front surface 14a. The vibratory devices 20 are respectively received in the recesses 18 and 19, so as to be incorporated into the seat back 10 (the seat pad 14). Thus, when the vibratory devices 20 vibrate, vibration generated by the vibratory devices 20 can be transmitted to the passenger via the seat pad 14. As shown in FIG. 2, the vibratory devices 20 are positioned laterally spaced from each other at a desired distance, so as to correspond the back of the passenger when the passenger is tilted against the passenger support surface 12 of the seat pad. 14. Further, the vibratory devices 20 are respectively connected to a sensor (not shown) that is capable of detecting drowsy driving of the passenger or lane departure of a vehicle. Thus, the vibratory devices 20 are capable of vibrating when a signal is transmitted thereto from the sensor, thereby notifying the passenger of impending dangers.

As best shown in FIGS. 4 and 5, the seat pad 14 may preferably include a wire member 30 (support member) that is incorporated thereinto by insert molding. Thus, the wire member 30 is integrally secured to the seat pad 14. The wire member 30 may preferably be composed of a lateral portion 32 that laterally extends along the passenger support surface 12 of the seat pad 14 and four vertical portions 34a-34d that respectively vertically extend along the passenger support surface 12 so as to be perpendicular to the lateral portion 32. The vertical portions 34a-34d may preferably be positioned so as to be in parallel with each other. Also, the vertical portions 34a-34d. may respectively be laterally oppositely positioned across the vibratory devices 20. The lateral portion 32 of the wire member 30 passes through the recesses 18 and 19 of the seat pad 14. In other words, the lateral portion 32 is exposed to the recesses 18 and 19, thereby forming uncovered portions 36 and 38 that are positioned in the recesses 18 and 19. The vibratory devices 20 are respectively attached to the uncovered portions 36 and 38 (which will be referred to as attachment portions 36 and 38). Remaining portions of the wire member 30 other than the attachment portions 36 and 38 are completely embedded in the seat pad 14. The embedded remaining portions of the wire member 30 (i.e., a central portion 32a positioned between the attachment portions 36 and 38 of the lateral portion 32 and the vertical portions 34a-34d) may function as a vibration transmission portion that is capable of transmitting vibration of the vibratory devices 20 along the passenger support surface 12 of the seat pad 14.

As shown in FIG. 3, the attachment portions 36 and 38 (one of which is shown) of the lateral portion 32 of the wire member 30 are inserted into insertion holes 24 formed in the vibratory devices 20, so that the vibratory devices 20 are rotatably supported via the attachment portions 36 and 38 within the recesses 18 and 19 of the seat pad 14. Further, the vibratory devices 20 may preferably be composed of main portions 20a and lid portions 20b that can be separated from each other along the insertion holes 24. Therefore, in order to attach the vibratory devices 20 to the attachment portions 36 and 38, the main portions 20a and the lid portions 20b are simply mated while the attachment portions 36 and 38 are positioned therebetween. Thereafter, the main portions 20a and the lid portions 20b are connected to each other. Thus, the vibratory devices 20 can be easily attached to the attachment portions 36 and 38. Further, the vibratory devices 20 (the lid portions 20b) may preferably be shaped so as to contact rear (bottom) surfaces 18a of the recesses 18 and 19 when the vibratory devices 20 are attached to the attachment portions 36 and 38. Conversely, the vibratory devices 20 may preferably be shaped so as to not contact side surfaces 18b of the recesses 18 and 19 when the vibratory devices 20 are attached to the attachment portions 36 and 38.

Next, an operation of the vehicle seat 1 (the seat back 10) will be described.

When the vibratory devices 20 vibrate, the vibration produced therefrom is transmitted to the passenger sitting on the vehicle seat 1 via the vibration transmission portion of the wire member 30 (i.e.,, the central portion 32a of the lateral portion 32 and the vertical portions 34a-34d) and the seat pad 14. At the same time, a rotative force caused by the vibration is applied to the vibratory devices 20. The applied rotative force urges the vibratory devices 20 to rotate about the attachment portions 36 and 38 of the wire member 30. At this time, due to the rotative force applied to the vibratory devices 20, the attachment portions 36 and 38 of the wire member 30 can slightly flex and the seat pad 14 can slightly deform. Therefore, the vibratory devices 20 can slightly rotate about the attachment portions 36 and 38. However, as described above, the vibratory devices 20 are positioned so as to contact the rear surfaces 18a of the recesses 18 and 19 of the seat pad 14. Therefore, the vibratory devices 20 can substantially be prevented from rotating about the attachment portions 36 and 38. Conversely, as described above, the vibratory devices 20 are positioned so as to not contact the side surfaces 18b of the recesses 18 and 19 of the seat pad 14. Therefore, the vibratory devices 20 can be oscillated about the attachment portions 36 and 38, so as to repeatedly hit or impinge the rear surfaces 18a of the recesses 18 and 19. When the rear surfaces 18a of the recesses 18 and 19 are impinged, the vibration of the vibratory devices 20 can be transmitted to the seat pad 14 in a thickness direction thereof and then be transmitted to the passenger.

Further, when the vibratory devices 20 vibrate, the vibration transmission portion of the wire member 30 (i.e., the central portion 32a of the lateral portion 32 and the vertical portions 34a-34d) can vibrate. Thus, the vibration of the vibratory devices 20 can be broadly transmitted to substantial portions of the seat pad 14 via the vibration transmission portion of the wire member 30. That is, the vibration of the vibratory devices 20 can be transmitted to portions of the seat pad 14 that do not directly correspond to the vibratory devices 20.

According to the vehicle seat 1 (the seat back 10), when the vibratory devices 20 vibrate, the vibratory devices 20 can be oscillated about the attachment portions 36 and 38, so as to repeatedly press or impinge the rear surfaces 18a of the recesses 18 and 19. As a result, the vibration of the vibratory devices 20 can be transmitted to the seat pad 14 in the thickness direction thereof.

Further, the vibration of the vibratory devices 20 can be broadly transmitted along the passenger support surface 12 of the seat pad 14 via the vibration transmission portion of the wire member 30.

Further, the vibratory devices 20 are respectively disposed in the recesses 18 and 19 of the seat pad 14 and are attached to the uncovered attachment portions 36 and 38 of the wire member 30 that is embedded in the seat pad 14. Therefore, the vibratory devices 20 can be securely attached to the seat pad 14 (the seat back 10).

Further, when the seat pad 14 is flexed by a loading that is. applied to the seat back 10 via the passenger, the wire member 30. can be flexed with the seat pad 14 because the wire member 30 is embedded in the seat pad 14. As a result, the vibratory devices 20 can be displaced in the same direction as the wire member 30 because the vibratory devices 20 are attached to the attachment portions 36 and 38 of the wire member 30. Therefore, the vibratory devices 20 do not provide discomfort to the passenger when the vibrating devices 20 are not operated or vibrated. As a result, the seat pad 14 can be reduced in thickness, if necessary.

Further, shape and arrangement of the vibration transmission portion of the wire member 30 can be changed, if necessary.

### Modified Form of First Embodiment

The first embodiment can be suitably modified. Modified forms of the first embodiment will now described with reference to FIGS. 6 to 9.

Because the modified forms relates to the first embodiment, only the constructions and elements that are different from the first embodiment will be explained in detail. Elements that are the same in the first embodiment will be identified by the same reference numerals and a detailed description of such elements may be omitted.

### First Modified Form

As shown in FIG. 6, a modified wire member 40 (support member) may preferably include a pair of rectangular frame-shaped portions 42a and 42b instead of the vertical portions 34a-34d of the wire member 30. The. frame-shaped portions 42a and 42b are respectively positioned so as to encircle the vibratory devices 20.

### Second Modified Form

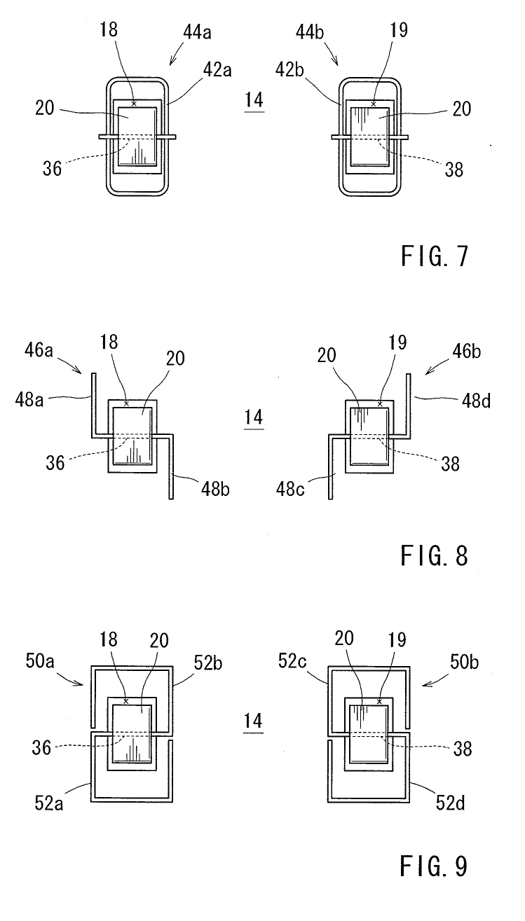

A wire member shown in FIG. 7 is a modified form of the wire member 40 of the first modified form. In the modified wire member, the central portion 32a of the lateral portion 32 is omitted, so that divided lateral portions are formed. Thus, the modified wire member is composed of a pair of wire member elements 44a and 44b (support member) that are separated from each other. Such a modified wire member is useful for independently vibrate the vibratory devices 20.

### Third Modified Form

A wire member shown in FIG. 8 is a modified form of the wire member of the second modified form. Similar to the second modified form, the modified wire member is composed of a pair of wire member elements 46a and 46b (support member). However, the modified wire member includes four bent portions 48a-48d in place of the frame-shaped portions 42a and 42b of the second modified form. The bent portions 48a-48d are respectively integrally formed in the divided lateral portions (the attachment portions 36 and 38) by bending the same vertically oppositely. Such a modified wire member can be relatively easily manufactured because the bent portions 48a-48d can be formed by simply bending the divided lateral portions.

### Fourth Modified Form

A wire member shown in FIG. 9 is a modified form of the wire member of the third modified form. Similar to the third modified form, the modified wire member is composed of a pair of wire member elements 50a and 50b. However, the modified wire member includes bent portions 52a-52d in place of the bent portions 48a and 48b of the third modified form. The bent portions 52a-52d are respectively bent such that the wire member elements 50a and 50b have frame-shapes that are capable of substantially encircle the vibratory devices 20.

### Second Detailed Representative Embodiment

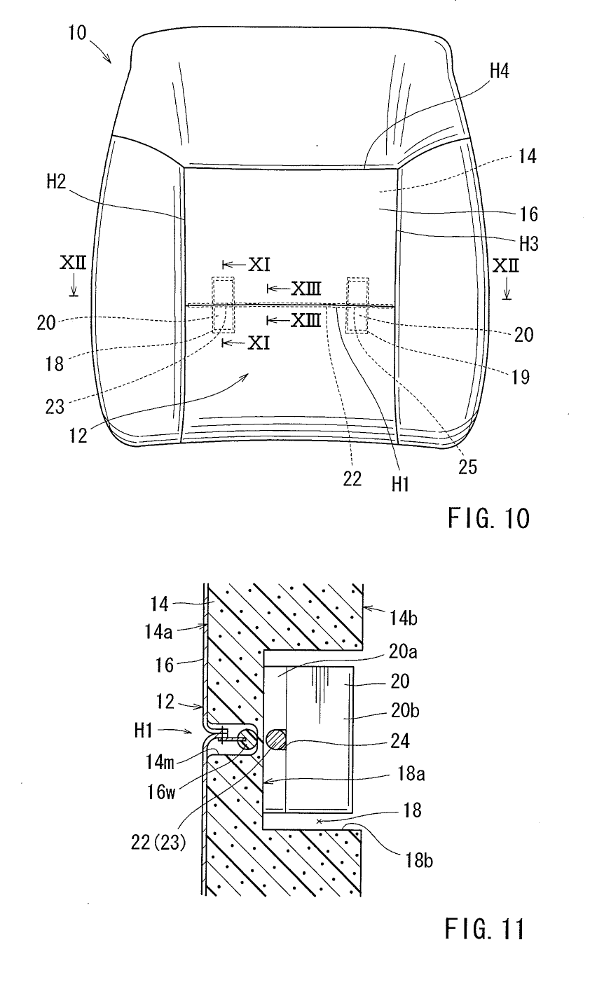

The second detailed representative embodiment will now described in detail with reference to FIGS. 10 to 13.

Because the second embodiment relates to the first embodiment, only the constructions and elements that are different from the first embodiment will be explained in detail. Elements that are the same in the first and second embodiments will be identified by the same reference numerals and a detailed description of such elements may be omitted.

As shown in FIG. 10, in this embodiment, the seat back 10 of the vehicle seat 1 has the substantially same construction as the first embodiment. However, the seat pad 14 may preferably include an insert wire 22 (support member) instead of the wire member 30 in the first embodiment. The insert wire 22 is incorporated into the seat pad 14 by insert molding. Further, unlike the first embodiment, the covering member 16 is attached to the front surface 14a of the seat pad 14 via anchor mechanisms H1-H4, so as to be reliably fitted thereto.

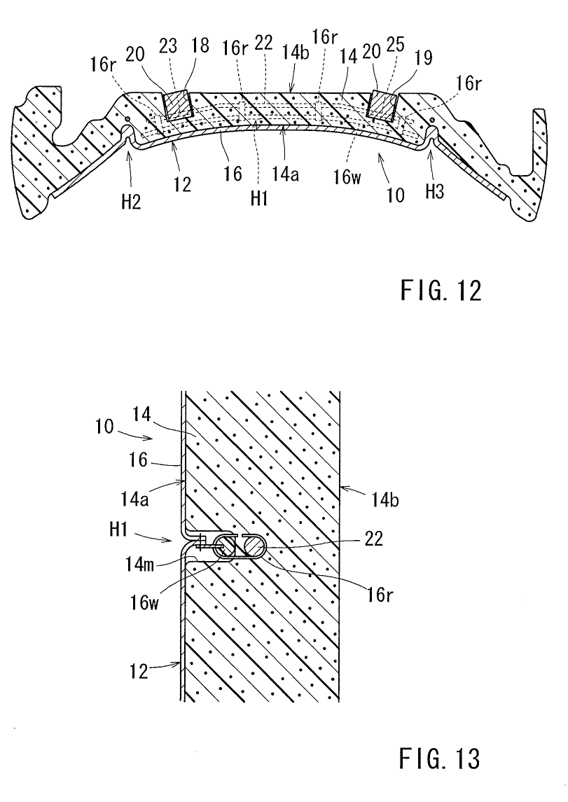

As shown in FIG. 10, the anchor mechanism Hi is positioned on a central portion of the passenger support surface 12 of the seat pad 14 and laterally extends therealong. As shown in FIGS. 12 and 13, the anchor mechanism HI is composed-of an anchor wire 16w that is attached to a rear (inner) surface of the covering member 16 and a plurality of C-shaped anchor members 16r that are positioned on the anchor wire 16w at desired distances. Conversely, formed in the seat pad 14 is a bottomed recess or groove 14m that is opened to the front surface 14a of the seat pad 14. As best shown in FIG. 13, the covering member 16 is attached to the front surface 14a of the seat pad 14 while the anchor wire 16w is received within the groove 14m. The anchor wire 16w is anchored and clamped to the insert wire 22 via the anchor members 16r. Further, each of the anchor mechanisms H2-H4 has the same construction as the anchor mechanism H1. Therefore, a detailed description of the anchor mechanisms H2-H4 may be omitted.

As shown in FIG. 10, the insert wire 22 is positioned so as to be aligned with the groove 14m. In other words, the insert wire 22 is positioned so as to be aligned with the anchor wire 16w of the anchor mechanism H1. Further, as shown in FIG. 12, the vibratory devices 20 are positioned so as to not interfere with the anchor members 16r attached to the anchor wire 16w. Further, as shown in FIG. 10, the vibratory devices 20 are respectively attached to attachment portions 23 and 25 of the insert wire 22 (which correspond to the attachment portions 36 and 38 of the wire member 30 in the first embodiment).

The insert wire 22 may operate similarly to the wire member 30 in the first embodiment. Therefore, the vehicle seat 1 (the seat back 10) may have the substantially same function and effects as the vehicle seat 1 in the first embodiment. In addition, in this embodiment, because the vibratory devices 20 are attached to the insert wire 22 of the anchor mechanism H1, it is not necessary to provide an additional member for supporting the vibratory devices 20. This may lead to reduced number of parts of the vehicle seat 1.

### Third Detailed Representative Embodiment

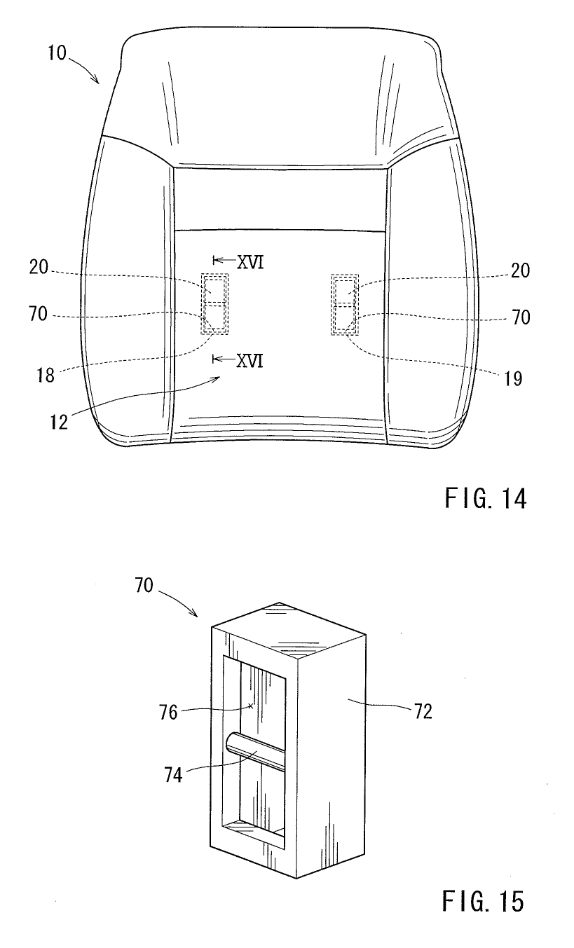

The third detailed representative embodiment will now described in detail with reference to FIGS. 14 to 16.

Because the third embodiment relates to the first embodiment, only the constructions and elements that are different from the first embodiment will be explained in detail. Elements that are the same in the first and third embodiments will be identified by the same reference numerals and a detailed description of such elements may be omitted.

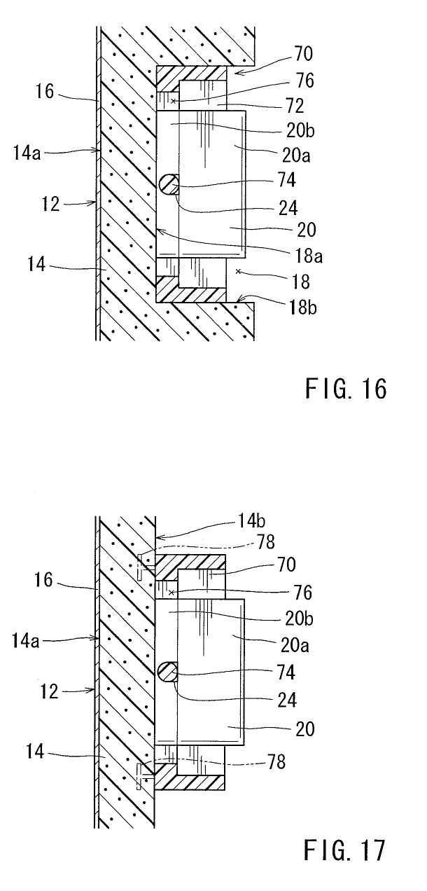

As shown in FIGS. 14 and 16, unlike the first embodiment, the vibratory devices 20 are respectively incorporated into the seat pad 14 via attachment brackets 70 (support member). The attachment brackets 70 are respectively shaped so as to be closely fitted to the recesses 18 and 19. As best shown in FIG. 15, each of the attachment brackets 70 is composed of a bottomed frame portion 72 that is-capable of receiving the vibratory device 20 and a shaft portion 74 that is attached to the frame portion 72. The frame portion 72 has an opening 76 that is formed in a bottom wall thereof. The shaft portion 74 is positioned in a substantially central portion of the opening 76 so as to transversely extend therein. The attachment brackets 70 thus constructed correspond to the wire member 30 in the first embodiment.

The vibratory devices 20 are received in the frame portions 72 of the attachment brackets 70 and are rotatably attached to the shaft portions 74 of the attachment brackets 70. As shown in FIG. 6, the vibratory devices 20 may preferably be shaped so as to be flush with bottom end surfaces of the frame portions 72 when the vibratory devices 20 are received therein. Further, the vibratory devices 20 .may preferably be shaped so as to not contact side surfaces of the frame portions 72 when the vibratory devices 20 are received therein.

The attachment brackets 70 having the vibratory devices 20 are respectively fitted to the recesses 18 and 19 and are secured therein. At this time, as shown in FIG. 16, the vibratory devices 20 contacts the rear surfaces 18a of the recesses 18 and 19. Thus, the vibratory devices 20 are respectively incorporated into the seat pad 14.

The attachment brackets 70 may operate similarly to the wire member 30 in the first embodiment. Therefore, the vehicle seat 1 (the seat back 10) may have the substantially same function and effects as the. vehicle seat 1 in the first embodiment. In addition, in this embodiment, because the vibratory devices 20 are respectively incorporated into the seat pad 14 via attachment brackets 70, the vibratory devices 20 can be easily incorporated into the seat pad 14.

### Modified Form of Third Embodiment

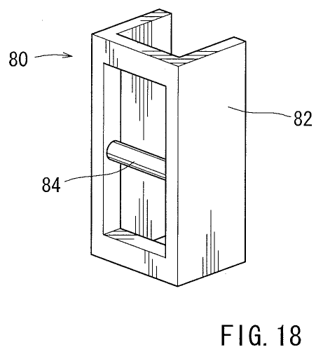

Modified forms of the third embodiment will now described with reference to FIGS. 17 and 18.

Because the modified forms relates to the third embodiment, only the constructions and elements that are different from the third embodiment will be explained in detail. Elements that are the same. in the first embodiment will be identified by the same reference numerals and a detailed description of such elements may be omitted.

### First Modified Form

As shown in FIG. 17, similar to the third embodiment, the vibratory devices 20 are respectively incorporated into the seat pad 14 via the attachment brackets 70. However, in this modified form, the attachment brackets 70 having the vibratory devices 20 are respectively connected to the rear surface 14b of the seat pad 14 via T-shaped connecter pins 78. The connector pins 78 are integrally formed in the attachment brackets 70 (the frame portion 72). The connector pins 78 are incorporated into the seat pad 14 by insert molding, so that the attachment brackets 70 can respectively be connected to the rear surface 14b of the seat pad 14. Thus, the vibratory devices 20 are respectively incorporated into the seat pad 14. However, the attachment brackets 70 can respectively be connected to the rear surface 14b of the seat pad 14 by adhesion and welding such as hot-melt adhesion.

### Second Modified Form

As shown in FIG. 18, in this modified form, attachment brackets 80 (support member) are used in place of the attachment brackets 70 in the third embodiment. Similar to the third embodiment, each of the attachment brackets 80 is composed of a frame portion 82 and a shaft portion 84. However, unlike the attachment brackets 70, the frame portions 82 of the attachment brackets 80 are partly removed.

Naturally, various changes and modifications may be made to the present invention without departing from the scope of the invention. For example, the vehicle seat 1 is not limited to the a driver's seat. Therefore, the vehicle seat 1 can be a front passenger seat, a rear seat or other such seats. That is, the present. invention can be applied to various vehicle seat in which vibration should be transmitted to the passenger via the seat pad 14. Also, the present invention can be applied to a seat cushion, a headrest, an ottoman of the vehicle seat 1.

What is claimed is:

1. A vehicle seat comprising.
a seat pad having a passenger support surface;
a vibratory device that is incorporated into the seat pad; and
a support member secured to the seat pad,
wherein the vibratory device is arranged and constructed to transmit vibration produced therefrom to a passenger sitting on the vehicle seat, and
wherein the vibratory device is rotatably supported on the support member.

2. The vehicle seat as defined in claim 1, wherein the support member comprises a wire member that is securely embedded in the seat pad,
wherein the wire member comprises an uncovered attachment portion that is formed by partly removing the seat pad and an embedded portion that extends along the passenger support surface,
wherein the vibratory device is attached to the uncovered attachment portion, so that the vibration of the vibratory device can be transmitted along the passenger support surface.

3. The vehicle seat as defined in claim 1, wherein the support member comprises an insert wire that is embedded in the seat pad,
wherein the seat pad is covered by a covering member, and
wherein the covering member is anchored to the insert wire via an anchor mechanism, so as to be fitted to the seat pad.

4. The vehicle seat as defined in claim 1, wherein the support member comprises an attachment bracket that is attached to the seat pad, and
wherein the vibratory device is attached to the attachment bracket.
